(19) United States
(12) Patent Application Publication
(10) Pub. No.: US 2015/0161662 A1
(43) Pub. Date: Jun. 11, 2015

(54) System and Method for Directing Online Advertising Across Multiple Channels

(71) Applicant: Acquisio, Brossard (CA)

(72) Inventors: Bryan Michael Minor, Mount Vernon, WA (US); Tamas Frajka, Southampton (GB)

(73) Assignee: Acquisio, Brossard (CA)

(21) Appl. No.: 14/101,674

(22) Filed: Dec. 10, 2013

(51) Int. Cl. G06Q 30/02

(52) U.S. Cl. CPC G06Q 30/0249; G06Q 30/0275; G06Q 30/0277

(57) ABSTRACT

In the present approach, a master computing system directs slave computing systems in the purchasing of advertising within one or more online advertising channels by building a set of models for predicting the outcome of advertising purchases based on data received from the advertising channels, evaluating those models to determine which one(s) to use, allocating an advertiser's budget across the slave systems and channels for a given time period, and adjusting those allocations during the time period based on performance results received from the slave systems. In turn, the slave systems attempt to purchase advertisements within their channels based on their allocation and adjustments and report performance results back to the master system.

### BACKGROUND

1. Field of the Invention

The present invention relates generally to internet advertising channels, and more particularly, to managing advertising campaigns across those online advertising channels.

2. Description of the Prior Art

Internet advertisers are finding more opportunities than ever to advertise. Not only is the number of ways to advertise online increasing, but each is constantly changing. The increasing complexity of deciding how to allocate a limited advertising budget is placing advertiser's businesses at peril. This complexity is compounded by the rapidity with which online advertising is bid for and purchased and the speed with which performance results from such advertising bids can be obtained. While all this could be performed manually, by the time that is done the advertising opportunity is typically long gone.

What is needed therefore is an automated way to deal with the complexity and range of online advertising possibilities, the rapidity of purchasing online advertising and the speed of obtaining online advertising results.

### SUMMARY

In one embodiment is a method for directing online advertising across multiple online advertising channels, the method comprising: preparing, by a master computing device, advertising buy data by calculating formulated data from channel data and separating the formulated data and channel data into three separate data sets; building, by the master computing device, predictive models using a first of the three separate data sets; choosing, by the master computing device, which of the predictive models to use by comparing results from running the predictive models using a second of the three separate data sets and eliminating those predictive models that indicate overfit when run using a third of the three separate data sets; predicting, by the master computing device, using the chosen predictive models, results of advertisements purchased in the multiple channels; allocating, by the master computing device, an advertising budget for a given time period for each of the multiple online advertising channels based on the predicted results: communicating the budget allocations across a network from the master computing device to one or more slave computing devices responsible for purchasing online advertisements within the channels; bidding, by the slave computing devices, for online advertisements within the channels based on the communicated budget allocations; communicating, across the network from the slave computing devices to the master computing device, performance results of the bidding for online advertisements; adjusting, by the master computing device, the budget allocation for one or more of the multiple online advertising channels based on the performance results; and communicating the adjusted budget allocation across the network from the master computing device to the slave computing devices responsible for purchasing advertisements within the one or more online advertising channels.

In another embodiment is a system for directing online advertising across multiple online advertising channels, the system comprising a master computing device and multiple slave computing devices. In this system, the master computing device comprises: a data parser configured to prepare advertising buy data by calculating formulated data from channel data and separating the formulated data and channel data into three separate data sets; a model builder configured to build predictive models using a first of the three separate data sets; a model tester configured to choose which of the predictive models to use by comparing results from running the predictive models using a second of the three separate data sets and eliminating those predictive models that indicate overfit when run using a third of the three separate data sets; and a prediction and allocation module configured to predict, using the chosen predictive models, results of advertisements purchased in the multiple channels, and allocate an advertising budget for a given time period for each of the multiple online advertising channels based on the predicted results. In this system, the each of the multiple slave computing devices is configured to bid for online advertisements within one or more online advertising channel based on the budget allocation, and communicate to the master computing device performance results of the bidding for online advertisements. In this system, the prediction and allocation module is further configured to adjust the budget allocation for one or more of the multiple online advertising channels based on the performance results.

In yet another embodiment is a non-transitory computer readable storage medium having stored thereupon computing instructions comprising: a master code segment to prepare advertising buy data by calculating formulated data from channel data and separating the formulated data and channel data into three separate data sets; a master code segment to build predictive models using a first of the three separate data sets; a master code segment to choose which of the predictive models to use by comparing results from running the predictive models using a second of the three separate data sets and eliminating those predictive models that indicate overfit when run using a third of the three separate data sets; a master code segment to predict, using the chosen predictive models, results of advertisements purchased in the multiple channels; a master code segment to allocate an advertising budget for a given time period for each of the multiple online advertising channels based on the predicted results; a master code segment to communicate the budget allocations across a network from the master computing device to one or more slave computing devices responsible for purchasing online advertisements within the channels; a slave code segment to bid for online advertisements within the channels based on the communicated budget allocations; a slave code segment to communicate across the network from the slave computing devices to the master computing device performance results of the bidding for online advertisements; a master code segment to adjust the budget allocation for one or more of the multiple online advertising channels based on the performance results: and a master code segment for communicating the adjusted budget allocation across the network from the master computing device to the slave computing devices responsible for purchasing advertisements within the one or more online advertising channels.

### BRIEF DESCRIPTION OF DRAWINGS

FIG. 1 is a block diagram of one embodiment of a system for directing online advertising across multiple online advertising channels.

FIG. 2 is a block diagram of further details of one embodiment of a system for directing online advertising across multiple online advertising channels.

FIG. 3 is a flow chart according to one embodiment of a method for directing online advertising across multiple online advertising channels.

### DETAILED DESCRIPTION

A multi-layer architecture is described for directing online advertising across multiple online advertising channels. This architecture uses a master and slave approach where the master is responsible for allocating an advertising budget across multiple slaves each of which is responsible for purchasing advertisements within its advertising channels based on its budget allocation. More specifically, the master, based on an advertising budget (e.g., a budget for a one month advertising period) received from a user of the system (the advertiser or someone acting on their behalf) and data received from the online advertising channels, generates an advertising budget allocation for a given time period (e.g., an update time period such as a 24 hour period) for each of the slaves by creating and choosing models which predict results of those advertisements. During that time period each slave, using knowledge of its own particular advertising channels, attempts to purchase advertisements within its online advertising channels in accordance with its budget allocation and reports performance results back to the master. Within that same time period and based on the performance results, the master then adjusts the channel's budget allocation for the time period. This process is then repeated for subsequent time periods with continued refinement in the created and chosen models, the budget allocations and the allocation adjustments. With this multi-layer architecture, the master computing system best allocates an advertiser's budget based on slave and channel performance while the complexity of purchasing advertisements in individual channels is contained within the slave computing modules.

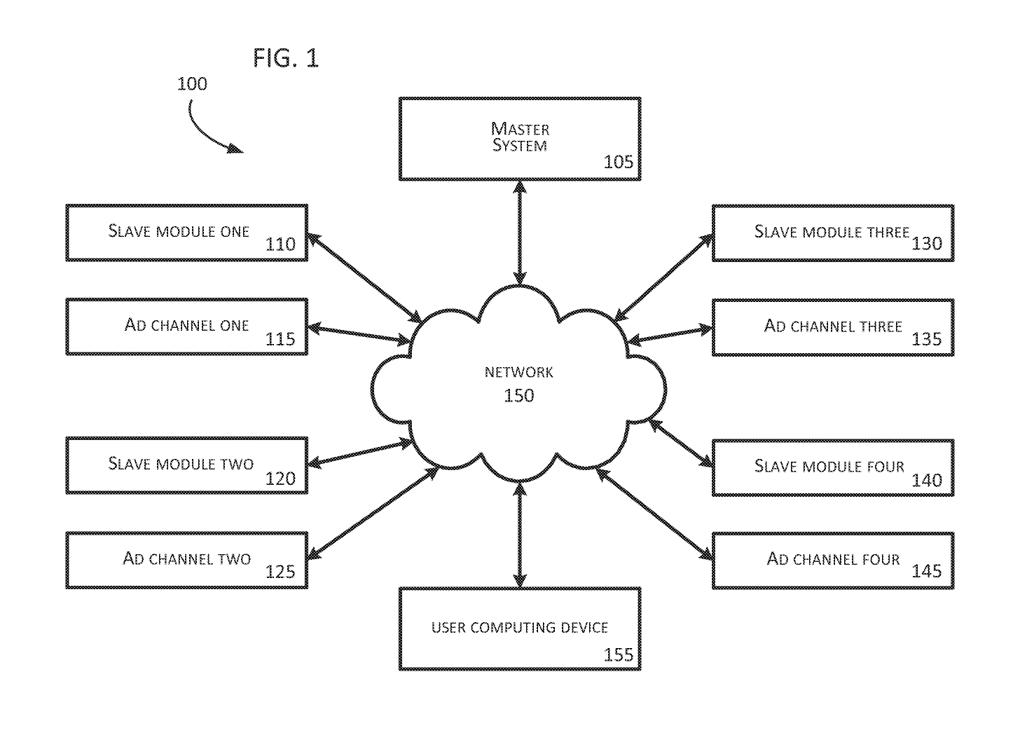

Referring now to FIG. 1, a block diagram of one embodiment of a system 100 for directing online advertising across multiple channels can be seen. System 100 comprises a master system 105 and one or more slave modules including in this example slave module 110, slave module 120, slave module 130 and slave module 140. Each of master system 105 and slave modules 110, 120, 130 and 140 is a server or other computing system, comprising one or more individual computing devices as known in the art, running program code that performs the functions described herein.

Master system 105 communicates with the slave modules via a network 150 which, in one example, is the internet but can be any known form of network communications. In an alternate embodiment, master system 105 communicates with one or more slave modules directly rather than via a network communication.

The slave modules in turn communicate over network 150 with advertising channels, such as for example slave module 110 communicating with advertising channel 115, slave module 120 communicating with advertising channel 125, slave module 130 communicating with advertising channel 135, and slave module 140 communicating with advertising channel 145.

It is to be understood by one of skill in the art that the online advertising channels referred to herein can be any one of now known or in the future developed channel. Examples of such channels include Google Adwords, Google Display Network, Google Search. Yahoo Search, Microsoft Bing Search, Facebook Exchange. Google DoubleClick Ad Exchange, AppNexus, Microsoft AdECN, Right Media Exchange, etc.

User computing device 155 of an advertiser, or someone acting on behalf of the advertiser, communicates over network 150 with the master system 105 to request online advertisements within a provided budget for an extended time period, e.g., one month. Additional information such as weighting value(s) can also be provided by user computing device 155 to master system 105 as explained further elsewhere herein.

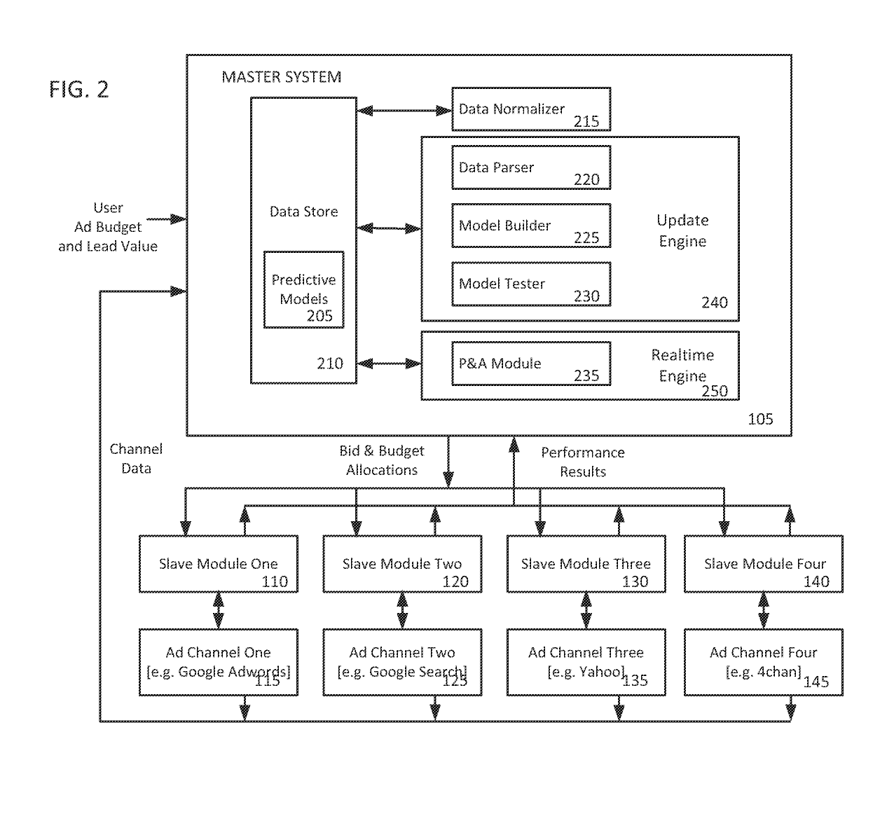

Referring now to FIG. 2, a block diagram of further details of one embodiment of a system for directing online advertising across multiple online advertising channels can be seen. As shown, master system 105 comprises a data store 210 used to store predictive models 205, a data normalizer 215, an update engine 240 and a realtime engine 250. Update engine 240 in turn comprises a data parser 220, a model builder 225, and a model tester 230. Realtime engine 250 in turn comprises a prediction and allocation module 235.

Data normalizer 215 is programming code or computing logic that normalizes performance results from the slave modules and channel data from the advertising channels using weighting value(s) provided by the user of the system, as explained elsewhere herein. Although shown as a separate module within master system 105, in another embodiment data normalizer 215 is included as a module within update engine 240.

Data parser 220 is programming code or computing logic that calculates formulated data from channel data, optionally cleans up data, and separates data into sets, each as explained further elsewhere herein.

Not shown in the figure but as would be understood by one of skill in the art is a communication module within master system 105 for handling communications between master system 105, user computing device 155, and the slave modules, each as described elsewhere herein.

Model builder 225 is programming code or computing logic that builds the predictive models 205, as explained further elsewhere herein.

Model tester 230 is programming code or computing logic that chooses which of the predictive models 205 to use, as explained further elsewhere herein.

Prediction and allocation module 235 is programming code or computing logic that determines slave module budget allocations and allocation adjustments, as explained elsewhere herein.

Data store 210 stores the predictive models 205, performance results received from the slave modules, and channel data received from the advertising channels, each as further explained elsewhere herein. Data store 210 is operating memory or long term storage of master system 105 or in another embodiment is a data storage device or system physically separate from and in communication with master system 105.

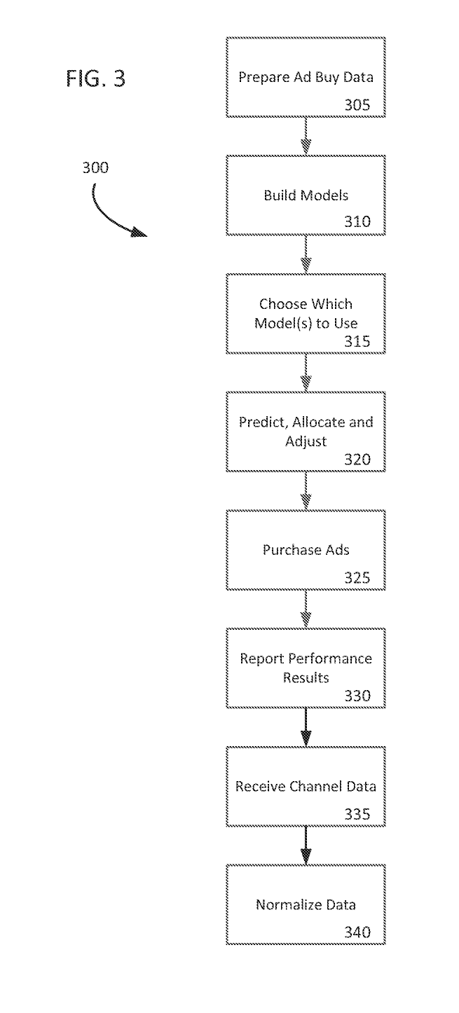

Referring now to FIG. 3, a flow chart according to one embodiment of a method 300 for directing online advertising across multiple online advertising channels can be seen.

In an operation 305, advertising buy data is prepared by calculating formulated data from channel data, optionally cleaning up data, and separating data into sets for further processing, as will now be explained according to one embodiment where data parser 220 prepares advertising buy data according to the following process.

Data parser 220 retrieves channel data from data store 210, which channel data was obtained by master system 105 from the advertising channels 115, 125, 135 and 145. As is known in the art, channel data comprises (i) cost of a purchased online advertisement, (ii) number of impressions of a purchased advertisement (the number of times a purchased advertisement was actually displayed online); (iii) number of clicks on a purchased advertisement (the number of times a displayed advertisement was actually clicked on or selected by someone viewing the displayed advertisement), and (iv) number of conversions of a purchased advertisement (e.g., the number of times a purchased advertisement resulted in either a consummated sale of the advertised item, the signing up for a free membership to a content sight, an email list sign up, the filling out of a lead generation form, or the user proceeding to a further page on the advertiser's website, etc.).

Data parser 220 calculates formulated data from the channel data. As is known in the art, formulated data comprises (i) cost per click (“CPC”, which is the cost of a purchased advertisement divided by the number of clicks on the purchased advertisement), (ii) cost per conversion (“CPA”, which is the cost of a purchased advertisement divided by the number of number of conversions of the purchased advertisement), (iii) conversion rate (the number of conversions of a purchased advertisement divided by the number of clicks on that purchased advertisement), and (iv) click through rate (the number of clicks on a purchased advertisement divided by the number of impressions of that purchased advertisement). As is also known in the art, each of these different types of formulated data are typically based on channel data from the same time period.

Data parser 220 optionally cleans up the channel and formulated data by identifying and correcting any errors or inconsistencies therein. For example, if the number of conversions is greater than the number of clicks, the number of conversions is reduced to make them equal. As another example, if the number of clicks is greater than the number of impressions, the number of clicks is reduced to make them equal. As still another example, if there are a number of clicks on a purchased advertisement yet there are no associated costs for the purchased advertisement, the number of clicks for that advertisement is deleted. Other clean up corrections may likewise be performed as would be recognized by one of skill in the art based on the teachings herein.

Data parser 220 separates the data into sets. In one embodiment, data parser 220 separates the collection of channel and formulated data into three separate data sets, each to be used by other modules of master system 105 as explained further elsewhere herein. These separate data sets contain the same type of data but can contain the same or differing amounts of data (e.g., each data set may be from a different period or length of time). These separate data sets are stored in data store 210 by data parser 220, to later be retrieved for use by other modules of master system 105, or are provided by data parser 220 to those other modules directly.

In an operation 310, predictive models 205 are built using the first separated data set. Predictive models 205 are a set of models which predict the outcome (e.g., impressions, clicks, conversions. CPC, CPA, etc.) of a given budget allocation for the purchase of a given online advertisement. Such models can include or use genetic algorithms, machine learning algorithms, Bayesian models, spline models, random forest trees, etc., all as known in the art.

In one embodiment, predictive models 205 are built by model builder 225 using the first separated data set. One example of such a predictive model 205 is the calculation of the coefficients for a mean model.

Another example is the creation of a budget allocation model for advertising between Google Search Network (GSN) and Google Display Network (GDN) campaigns. One group of one or more campaigns are controlled by a Slave to advertise on only GDN, while another Slave advertises just on GSN. Using performance data for the first separated data set from all the GDN campaigns, which would include data such as impressions, clicks, conversions, and cost, the model builder then generates a number of random forest ensemble solutions for predicting their performance. These predictions of GDN performance include how much this group of campaigns can spend for a given quality of result, such as number of clicks versus CPC, or number of conversions versus CPA. Similarly, for the GSN set of campaigns a number of different random forest ensemble solutions for predicting their performance is generated from the first separated data set. These predictions are the basis used by the Master for deciding how to allocate the budget for a given budget period (e.g., daily) between the GDN and GSN group of campaigns. As would be understood by one of skill in the art based on the teachings herein, many different math modeling techniques can be used for performing these predictions of performance for the respective Slave group performance, then with these predictions (independent of how they are formulated) the Master uses them to decide how best to allocate the budget between these Slave groups.

In an operation 315, which of the predictive models to use is chosen by reducing (i.e., thinning) the number of predictive models based on a competitive comparison between them and eliminating those remaining predictive models that are overfit.

As is understood by one of skill in the art, overfit is a condition where a model performs very well on one set of data yet performs poorly on another set of data. Testing for overfit is therefore a screening or sanity check on a model.

In one embodiment, model tester 230 chooses which predictive model(s) to use by thinning the number of predictive models and eliminating those with overfit according to the following process.

Model tester 230 runs the predictive models 205 using the second set of separated data to determine how accurately each predictive model predicts results by rank ordering them. Model tester 230 then selects those predictive models 205 having the highest rank order and/or clearly showing superior results as would be understood by one of skill in the art based on the teachings herein. The total number of predictive models 205 selected is either set by master system 105 or as specified by the user of the system.

Model tester 230 then tests the selected models for overfit by running the models using the third set of separated data and comparing the results against those from running the models using the second set of separated data. The model tester 230 then removes any of the selected models that indicate overfit so they will not be used thus resulting in one or more chosen predictive model(s). Ultimately the final model(s) used for performing a prediction is a competition across all models ever generated over time, with the top performer(s) being used.

In an operation 320, predictions are made by the chosen predictive model(s) using the performance data and allocations are then made, with subsequent adjustments to those allocations, based on those predictions as will now be explained according to one embodiment where prediction and allocation module 235 does so according to the following process.

Prediction and allocation module 235 creates predictions of slave module performance in purchasing online advertising within the advertising channels by running the chosen predictive model(s) using performance data obtained from the slave modules. The performance data is obtained either by retrieving the performance data from data store 210 or directly from the slave modules themselves. Using the performance data provides predictions based on recent results from the slave modules' online advertising purchasing activity within the advertising channels as explained elsewhere herein.

Prediction and allocation module 235 uses the predictions to allocate a budget for each slave module to purchase advertising in a given time period (e.g., for the next 24 hour update time period) taking into account the predicted performance of each slave module and advertising channel relative to each other slave module and advertising module. In other words, prediction and allocation module 235 evaluates the predicted performance of all the slave modules and advertising channels to determine how best to allocate the user's advertising budget for that time period for each slave module and advertising channel.

In one example of determining a budget allocation for a given slave module and advertising channel, prediction and allocation module 235 looks at a user's advertising budget (which may be referred to as a budget group since it is a group of advertising campaigns) for a monthly time period and uses a selected predictive model to predict what will likely be spent by a given slave module in purchasing advertisements in a particular advertising channel. For example, this can be done by subtracting however much has already been spent in the current month from the user's advertising budget for that month and then dividing the remainder by however many days are left in that month to determine a target budget allocation for that day time period. The target budget is then refined by, for example, taking into account factors known in the art such as the maximum amount that can be spent in that particular advertising channel in a single day (since there are limits on how much available advertising exists in a given day) and the precision in a given advertising channel (since, again, there is no guarantee that all advertisements bid on will result in actual purchased advertisements), etc.

Using the prediction models created by the Modeler, then the total budget for a given budget time period (e.g. one day) are then used to determine how much budget to allocate to each of its respective Slaves. One example is where there are slaves for each of the following advertising channels: Google Display Network (GDN), Google Search Network (GSN), Bing Search (BS), and Facebook Exchange (FBX). For this example the optimization is for maximization of clicks for the overall budget spend (an analogous example is maximizing conversions). Assume the value of a click from each of these Slaves is given by: CPCV_GDN (CPC value for GDN), CPCV_GSN (CPC value for GSN), CPCV_BS (CPC value for Bing Search), and CPCV_FBX (CPC value for Facebook Exchange). Assuming in this example that the largest values of these is the CPCV_GSN, then the normalized ratio of click value for each is: {N_CPCV_GDN=(CPCV_GDN/CPCV_GSN)}, {N_CPCV_GSN=(CPCV_GSN/CPCV_GSN)=1}, {N_CPCV_BS=(CPCV_BS/CPCV_GSN)}, and {N_CPCV_FBX=(CPCV_FBX/CPCV_GSN)}. The predictive models for each Slave are then used to formulate the number of clicks produced for a given average CPC of the Slave over the Budget time period. The individual Slaves compete fairly by comparing the total overall spend across all 4 for the same normalized average CPC. In this case, if the target average CPC for the GSN Slave is avgCPC_{—}1, then the target average CPC for each is: {avgCPC_Target_GDN=avgCPC_{—}1*N_CPCV_GDN}, {avgCPC_Target_GSN=avgCPC_{—}1}, {avgCPC_Target_BS=avgCPC_{—}1*N_CPCV_BS}, and {avgCPC_Target_FBX=avgCPC_{—}1*NCPCV_FBX}. Using these target values for average CPC for each Slave, then the respective Slave performance prediction model for the number of clicks produced for a given average CPC is used to formulate the total spend during a given budget period when using an average CPC target for the GSN Slave of avgCPC_and the related other Slave target values is as follows: (Total_Budget_Spend)={PredictedClicks_GDN[avgCPC_Target_GDN]*avgCPC_Target_GDN}+{PredictedClicks_GSN[avgCPC_{—}1]*avgCPC_{—}1}+{PredictedClicks_BS[avgCPC_Target_BS]*avgCPC_Target_BS}+{PredictedClicks_FBX[avgCPC_Target_FBX]*avgCPC_Target_FBX}. (The PredictedClicks_GDN[avgCPC_Target_GDN] is the functional prediction produced by the Modeler of the number of clicks for the GDN case for the budget period given an input having an average CPC of (avgCPC_Target_GDN), and this is similarly true for the other cases.) Since the (Total_Budget_Spend) for the Budget period is known and this equation for it depends on the value (avgCPC_{—}1), since each target average CPC is expressed in terms of this value, then the Master determines the value of (avgCPC_{—}1) to exactly spend the budget, call it (CPC_Budget), and then this value is used to give the following budget allocations for each of the Slaves as: {Budget_GDN=PredictedClicks_GDN[CPC_Budget*N_CPCV_GDN]*(CPC_Budget*N_CPCV_GDN)}, {Budget_GSN=PredictedClicks_GSN[CPC_Budget]*(CPC_Budget)}, {Budget_BS=PredictedClicks_BS[CPC_Budget*N_CPCV_BS]*(CPC_Budget*N_CPCV_BS)}, {Budget_FBX=PredictedClicks_FBX [CPC_Budget*N_CPCV_FBX]*(CPC_Budget*N_CPCV_FBX)}

the portion of the total budget that is allocated for the next budget period for each of these Slave advertising channels.

Predication and allocation module 235 then makes adjustments to those allocations by comparing the performance results of the slave modules against the predicted results.

For example, if a slave module's performance results are not meeting the predicted results then that slave module's budget allocation can be reduced thus freeing up funds which can be used to increase another slave module's budget allocation.

As another example, if a slave module's performance results for a given advertising channel are not meeting the predicted results then that slave module's budget allocation can be adjusted by redirecting it to another advertising channel handled by that slave module.

The prediction algorithms learn from previous results and trends from Slave performance and are actively adjusted to deal with underperforming Slaves. For example, based on data showing the budget given to the Google Search Network (GSN) Slave is not being spent fully and the Google Display Network (GDN) is running out early in the budget period, then the predictions are adjusted by the Modeler to more accurately model reality. The accuracy of the predictive models produced by the Modeler is key to proper Budget allocations by the Master. The Modeler is constantly updating its models to make the budget allocation predictions optimal.

The budget allocations, and subsequent adjustments, are communicated from master system 105 to each respective slave module such as slave module one 110, slave module two 120, etc.

In an operation 325, slave modules attempt to purchase online advertisements in their respective online advertisement channels based on their budget allocations, as will now be explained according to one embodiment where slave modules do so according to the following process.

As an example, slave module one 110 places bids for advertisements in an advertising channel such as Google Search (where, as is known in the art, advertisements are placed near displayed online search results based on advertiser's having competitively bid for such advertisement placement).

In an operation 330, slave modules report performance results of their attempted and purchased advertisements in online advertisement channels, as will now be explained according to one embodiment where slave modules do so according to the following process.

As an example, slave module one 110, having now purchased advertisements in online advertisement channels based on having placed bids for such advertisements as described with reference to operation 325, reports those performance results back to master system 105.

In an operation 335, channel data is received from the advertising channels, as will now be explained according to one embodiment where a master system does so according to the following process.

As an example, master system 105 receives channel data from advertising channel one 115 which received channel data can then be stored in data store 210 for use by the various modules within master system 105 to perform the various operations as explained elsewhere herein.

In an operation 340, data is normalized, as will now be explained according to one embodiment where the data is normalized according to the following process.

As an example, data normalizer 215 normalizes data based on weighting values received from a user of the system. For example, a user determines that a click on average is worth one amount to them for one type of advertisement (e.g., that a click on average for mobile advertising on a search is worth $0.80 to them) and worth another amount to them for another type of advertisement (e.g., that a click on average for desktop advertising on a search is worth $1.00 to them). According to this example, data normalizer 215 normalizes the data by dividing each purchased advertisement of the given type by its user-provided valuation. In other words, if the data indicates that a purchased mobile advertisement on a search cost $0.90, then the resulting normalized data would be 1.125 ($0.90/$0.80). Likewise, if the data indicates that a purchased desktop advertisement on a search cost $0.90, then the resulting normalized data would be 0.90 ($0.90/$1.00). This normalization provides a relative weighting of the data based on the user's determination of value. The normalized data is then made available to the other modules within master system 105, either directly or by storing them in data store 210.

Another example of data normalization, given campaign A produces conversions worth $50.00 per sale for an advertiser, while campaign B produces conversions worth $250 per sale. Given this vast disparity between sale values, or any difference, the resulting CPC bidding conducted while these compete is proportionally decreased so the less valuable sale bid is proportionally less. For this specific case, if the CPC bid for Campaign B is $1.00, then CPC bid for Campaign A is (bid_A=$1*(50/250)=$0.20), and as CPC bids are varied over time this proportional relationship between campaigns A and B is held; this ensures fair competition between them.

The process then continues in various fashions as desired in a given embodiment or use case. In one embodiment, the normalization process operation 340 is followed by the adjustment allocation operation 320, and the subsequent operations as has been described, within the given time period. And this cycle can then be repeated a number of times within the given time period thereby refining the budget allocation for the slaves and channels within the given time period. In another embodiment, the report performance results operation 330 is followed by the adjustment allocation operation 320, and the subsequent operations as has been described, within the given time period. This cycle can likewise then be repeated a number of times within the given time period also thereby refining the budget allocation for the slaves and channels within the given time period. In still another embodiment, the normalization process operation 340 is followed by the prepare ad buy data operation 305, and the subsequent operations as has been described, for the given time period and/or for another given time period, again to continually refine the budget allocations. Other cycles will be apparent to one of skill in the art based on the teachings herein.

It is to be understood that the examples given are for illustrative purposes only and may be extended to other implementations and embodiments. While a number of embodiments are described, there is no intent to limit the disclosure to the embodiment(s) disclosed herein. On the contrary, the intent is to cover all alternatives, modifications, and equivalents apparent to those familiar with the art.

It is to be further understood that the embodiments discussed herein can all be implemented in software stored in a computer readable storage medium for access as needed to either run such software on the appropriate processing hardware.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for directing online advertising across multiple online advertising channels, the method comprising:
preparing, by a master computing device, advertising buy data by calculating formulated data from channel data and separating the formulated data and channel data into three separate data sets;
building, by the master computing device, predictive models using a first of the three separate data sets;
choosing, by the master computing device, which of the predictive models to use by comparing results from running the predictive models using a second of the three separate data sets and eliminating those predictive models that indicate overfit when run using a third of the three separate data sets,
predicting, by the master computing device, using the chosen predictive models, results of advertisements purchased in the multiple channels;
allocating, by the master computing device, an advertising budget for a given time period for each of the multiple online advertising channels based on the predicted results;
communicating the budget allocations across a network from the master computing device to one or more slave computing devices responsible for purchasing online advertisements within the channels;
bidding, by the slave computing devices, for online advertisements within the channels based on the communicated budget allocations;
communicating, across the network from the slave computing devices to the master computing device, performance results of the bidding for online advertisements;
adjusting, by the master computing device, the budget allocation for one or more of the multiple online advertising channels based on the performance results; and
communicating the adjusted budget allocation across the network from the master computing device to the slave computing devices responsible for purchasing advertisements within the one or more online advertising channels.

2. The method of claim 1 wherein channel data comprises cost of a purchased online advertisement, a number of impressions of the purchased online advertisement, a number of clicks on the purchased online advertisement, and a number of conversions of the purchased online advertisement.

3. The method of claim 1 wherein formulated data comprises cost per click, cost per conversion, conversion rate and click through rate.

4. The method of claim 1 wherein preparing advertising buy data further comprises cleaning up erroneous and inconsistent data.

5. The method of claim 1 wherein the predictive models use machine learning algorithms.

6. The method of claim 1 wherein predicting using the chosen predictive models results of advertisements purchased in the multiple channels comprises using channel data and formulated data.

7. The method of claim 1 further comprising normalizing the formulated data based on one or more user provided weighting values.

8. The method of claim 7 wherein predicting using the chosen predictive models results of advertisements purchased in the multiple channels comprises using channel data and normalized formulated data.

9. The method of claim 1 further comprising repeating the steps of allocating, communicating, bidding, communicating and adjusting multiple times within the given time period.

10. The method of claim 1 wherein the given time period is an update time period.

11. The method of claim 10 wherein the update time period is 24 hours.

12. A system for directing online advertising across multiple online advertising channels, the system comprising:
a master computing device comprising:
a data parser configured to prepare advertising buy data by calculating formulated data from channel data and separating the formulated data and channel data into three separate data sets;
a model builder configured to build predictive models using a first of the three separate data sets;
a model tester configured to choose which of the predictive models to use by comparing results from running the predictive models using a second of the three separate data sets and eliminating those predictive models that indicate overfit when run using a third of the three separate data sets; and
a prediction and allocation module configured to:
predict, using the chosen predictive models, results of advertisements purchased in the multiple channels; and
allocate an advertising budget for a given time period for each of the multiple online advertising channels based on the predicted results; and
multiple slave computing devices each configured to:
bid for online advertisements within one or more online advertising channel based on the budget allocation; and
communicate to the master computing device performance results of the bidding for online advertisements;
wherein the prediction and allocation module is further configured to adjust the budget allocation for one or more of the multiple online advertising channels based on the performance results.

13. The system of claim 12 wherein the data parser is further configured to clean up erroneous and inconsistent data.

14. The system of claim 12 wherein the prediction and allocation module configured to predict, using the chosen predictive models, results of advertisements purchased in the multiple channels comprises using channel data and formulated data.

15. The system of claim 12 wherein the master computing device further comprises a data normalizer configured to normalize the formulated data based on one or more user weighting value.

16. The system of claim 15 wherein the prediction and allocation module configured to predict, using the chosen predictive modules, results of advertisements purchased in the multiple channels comprises using channel data and normalized formulated data.

17. The system of claim 12 wherein the given time period is an update time period.

18. The system of claim 17 wherein the update time period is 24 hours.

19. A non-transitory computer readable medium having stored thereupon computing instructions comprising:
a master code segment to prepare advertising buy data by calculating formulated data from channel data and separating the formulated data and channel data into three separate data sets;
a master code segment to build predictive models using a first of the three separate data sets;
a master code segment to choose which of the predictive models to use by comparing results from running the predictive models using a second of the three separate data sets and eliminating those predictive models that indicate overfit when run using a third of the three separate data sets,
a master code segment to predict, using the chosen predictive models, results of advertisements purchased in the multiple channels;
a master code segment to allocate an advertising budget for a given time period for each of the multiple online advertising channels based on the predicted results;
a master code segment to communicate the budget allocations across a network from the master computing device to one or more slave computing devices responsible for purchasing online advertisements within the channels;
a slave code segment to bid for online advertisements within the channels based on the communicated budget allocations;
a slave code segment to communicate across the network from the slave computing devices to the master computing device performance results of the bidding for online advertisements;
a master code segment to adjust the budget allocation for one or more of the multiple online advertising channels based on the performance results; and
a master code segment for communicating the adjusted budget allocation across the network from the master computing device to the slave computing devices responsible for purchasing advertisements within the one or more online advertising channels.

20. The non-transitory computer readable medium of claim 19 further having stored thereupon computing instructions comprising:
a master code segment to clean up erroneous and inconsistent data.

21. The non-transitory computer readable medium of claim 19 further having stored thereupon computing instructions comprising:
a master code segment to normalize the formulated data based on one or more user weighting value.
